(19) United States
(12) Patent Application Publication
(10) Pub. No.: US 2020/0320455 A1
(43) Pub. Date: Oct. 8, 2020

(54) QUEUE MANAGEMENT WITH DYNAMIC PRIORITIZATION

(71) Applicant: MICROSOFT TECHNOLOGY LICENSING, LLC, Redmond, WA (US)

(72) Inventors: Shao Ou CHIN, Redmond, WA (US); Rajkumar KAMAYASWAMI, Redmond, WA (US); Qi XUE, Bellevue, WA (US); Trevor Eugene NIES, Sammamish, WA (US)

(21) Appl. No.: 16/376,887

(22) Filed: Apr. 5, 2019

(51) Int. Cl. G06Q 10/06; G06F 16/9038; G06F 16/904; G06F 16/903; G06F 3/0482

(52) U.S. Cl. CPC G06Q 10/06316; G06F 16/9038; G06Q 10/06311; G06F 16/90335; G06F 3/0482; G06F 16/904

(57) ABSTRACT

Dynamic queue management is achieved by using a default priority score in combination with ordered logic subsets (“views”) of the queue. A single number that is a priority score for an item, represents the relative priority of that item in a queue. Priority scores are based on the priorities assigned to tiers and attributes. A view of items from the queue is created based on a set of rules that correspond to a specific segment of the queue. One or more views may be assigned to one or more agents. Views are prioritized for each agent. A user interface provides techniques for real-time ordering of the views associated with an agent according to the priorities of those views. The ordering of the queue is maintained for the items in a view. An agent is assigned an item from a view and then the item is removed from the queue.

### BACKGROUND

Worker management or task management may include managing many different types of queues. A queue may represent a “to do list” that is shared across many individuals or groups within an organization. Creating a static list of items in a queue may be sufficient for simple scenarios. However, as the number of items and the types of these items in a queue increase, and the number of people with various skill sets available to work on those items increases, the complexity quickly exceeds that which can be handled by a simple list and a prescribed prioritization scheme. Additionally, frequently re-adjusting the priority of items in a large queue based on the interaction of multiple factors can become a complex task that requires both substantial manual efforts and engineering development cycles, and therefore result in reduced productivity and may even render the process unmanageable.

It is with respect to these and other considerations the disclosure made herein is presented.

### SUMMARY

The disclosure presents a general methodology for prioritizing work items in a queue management system by setting default prioritization scores based on item attributes, creating customized views to segment work items, and customizing view priorities for individual agents and teams. The work items could be such things as responding to customer emails, manually reviewing online content, evaluating insurance claims, processing medical billing entries, resolving issues submitted to an IT helpdesk, or any other type of task item. The techniques presented in this disclosure are broadly applicable to a number of different industries and fields.

Effective management of a queue of items is an optimization problem that includes identifying at any point in time the most important task and allocating that tasks to an agent capable of acting on the task. This involves both item prioritization with respect to other items and item allocation so that each agent is working on a task he or she is well-suited to address. A modern workplace queue management system may contain multiple queues each with tasks of varying importance that are distributed to multiple individuals each with different skill sets suited for different types of tasks. Therefore, agent capabilities and task requirements may constrain the allocation options for items in a queue.

Each item in the queue may be assigned a priority score that is represented as a numeric value such as an integer. The value of the integer may encode both priority rules and characteristics of the queue item. The priority score may be created from a concatenation of values representing attributes of the item and the order in which the values are concatenated represents the relative importance of the attributes. Numeric values are amenable to rapid and computationally efficient sorting thereby enabling re-ordering of items in the queue with less processor and memory usage than other techniques.

Items in the queue may be assigned to an agent such as an individual or a worker to respond to the item in the queue. The type of response depends on the type of task or activity that is represented by an item. Upon assigning an item from the queue to an agent, the item may be removed from the queue so that it will not be assigned multiple times.

Logic subsets of items in the queue may be presented in various views. Views may be limited by attributes of the items. Thus, a given view may include only those items that have one or more specified attributes. One or more views may be assigned to entities such as workers, agents, or teams, and these views are ordered according to their priority. Items within a view may maintain a default ordering of the items that is the same as the ordering of the items in a queue. Entities may be able to select an item from available views to work on or entities may be assigned, without choice, the highest-priority item from their available views.

Management of the item attribute values and relative importance of various attributes may be managed through a user interface (UI) that provides a way for a user to manipulate the factors that affect the ranking of items in the queue without requiring the user to calculate or even view the underlying priority scores for the queue items. The UI can also provide an interface for creating views and assigning one or more views to one or more entities.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter. Furthermore, the claimed subject matter is not limited to implementations that solve any or all disadvantages noted in any part of this disclosure. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 shows an illustrative architecture for managing a queue of items.

FIG. 2 shows an illustrative queue of items formatted as a table.

FIG. 3 shows an illustrative priority score.

FIG. 4 shows an illustrative queue management UI.

FIG. 5 shows an illustrative view creating UI.

FIG. 6 shows an illustrative view assignment UI.

FIG. 7 shows four different UIs each displaying a different view.

FIG. 8 shows four different item acceptance UIs for agents.

FIG. 9 shows an illustrative process for ordering items in a queue.

FIG. 10 shows an illustrative process for using a view to manage a queue of items.

FIG. 11 is a computer architecture diagram illustrating an illustrative computer hardware and software architecture for a computing system capable of implementing aspects of the techniques and technologies presented herein.

FIG. 12 is a diagram illustrating a distributed computing environment capable of implementing aspects of the techniques and technologies presented herein.

### DETAILED DESCRIPTION

This disclosure describes techniques for queue management with dynamic prioritization. A queue contains a collection of items. The items may represent tasks that a human user needs to complete such as reviewing online content or answering a customer email. The tasks may pertain to any type of field or industry such as business, insurance, information technology, airlines, case management, customer support, etc. For example, the queue may represent a to-do list of tasks related to such things as risk review, fraud detection, identification of policy violations, etc. The queue may be implemented as entries in a database table, a list in a flat file, or another data structure.

This techniques of this disclosure manage a queue of items such that at any point in time that the most items from the queue are being worked on by available individuals and that the allocation of work to the individuals is optimized, in a setting where a queue management system is used by humans and multiple queues containing tasks of various importance are involved and individuals have different skill sets suited for different types of tasks. These techniques will benefit the efficiency of operation for all manual review systems that involve queue prioritization.

Items in the queue include attributes such as an urgency or priority level (e.g., high, medium, or low), a time of creation or entry into the queue (e.g., a timestamp), a type of issue represented by the item (e.g., hardware, customer complaint, legal compliance, etc.), or another type of attribute. Attributes of the items, but not necessarily every attribute, are used to prioritize items with respect to each other. For example, items with a high urgency level may be prioritized before items with a medium urgency level. Similarly, items related to legal compliance may receive a higher priority than customer complaints.

The items in the queue may be ordered according to a priority ranking based on the attributes of the items. The priority ranking may represent a level of urgency with which human attention is needed for an item in the queue. However, in some implementations items in the queue may be unordered or in a random order. For example, items in the queue may be ordered not by prioritization but by the time of entry into the queue.

The ordering of items in the queue is also able to be updated dynamically in real time. The relative importance of attributes may change over time based on changing conditions. Adjustment to the priority of attributes may be implemented with a user interface that provides an intuitive mechanism for adjusting the relative rank of attributes.

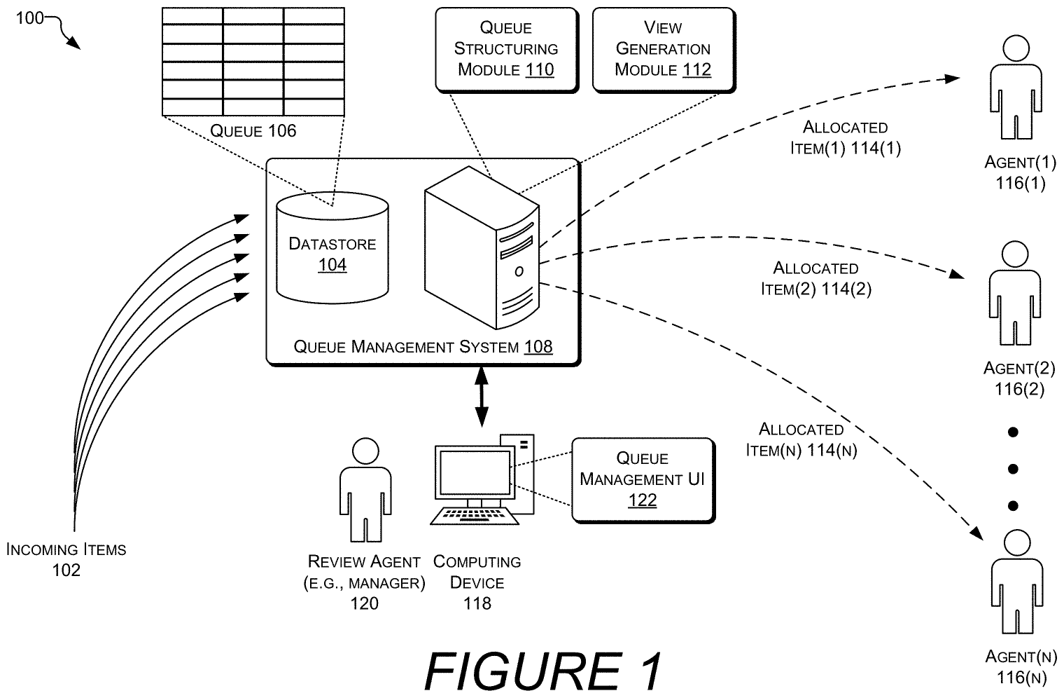

FIG. 1 shows an illustrative architecture 100 for managing a queue of items and allocating items from the queue. Incoming items 102 represent any number of various types of items that require human attention such as tasks to be completed, messages to be read, content to be evaluated, and the like. The sources of the incoming items 102 may depend on the type of items and may include sources such as email messages, automated generation such as through artificial intelligence, external lists, and the like.

The incoming items 102 may be placed into a datastore 104. The datastore 104 may be implemented as a database or other system for storing records. The database may be managed and records may be manipulated using any type of database language such as SQL. A queue 106 is maintained within the datastore 104. The queue 106 may be structured as database entries, a table, list, or other data structure. The incoming items 102 are included in the queue 106.

The datastore 104 may be part of a queue management system 108 that includes one or computing systems capable of interacting with the datastore 104 to dynamically modify the prioritization of items in the queue 106. The queue management system 108 may be implemented as a server, group of servers, or cloud-based system that is distributed across one or more physical locations using one or more discrete computing devices.

The queue management system 108 includes at least a queue structuring module 110 and a view generation module 112. The queue structuring module 110 may assign a default priority to the items in the queue 106. The default priority prioritizes items in the queue 106 linearly using customizable criteria. The customizable criteria may include one or more rules that rank different types of attributes with respect to each other and rank different characteristics of individual attributes. The characteristics of each individual item in the queue 106 are analyzed according to the customizable criteria and ranking rules to assign a priority score.

The view generation module 112 creates one or more views that represent subsets of the items in the queue 106. A view is a segment of the queue 106 that meets a set of criteria. A view may be created by generating a logic subset of items from the queue 106 that have attributes specified by the set of criteria. Within a view, the items may be ordered using the same default priority assigned to the queue 106 as a whole. The view generation module 112 may receive indications of the criteria and identify items in the queue 106 for inclusion in a view. A view may be changed by adding or removing criteria and these changes may be implemented using the view generation module 112.

The queue management system 108 may also distribute items from the queue 106. Items may leave the queue 106 when they are allocated to a person for that person to address the item by accepting the corresponding work task. The work task may include a variety of different activities depending on the specific work task such as contacting a customer, writing an email, classifying Internet content is appropriate or inappropriate, resolving a technical problem, determining a medical billing code, or the like. Multiples allocated items 114(1), 114(2), 114(n) may be allocated from the queue 106 to individual agents 116(1), 116(2), 116(n). Although only three allocated items 114 and three agents 116 are shown in this illustrative architecture 100, the queue management system 108 may function with a much greater number of allocated items 114 and agents 116. The allocation of an allocated item 114 from the queue 106 to an agent 116 may be based on the priority of the allocated item 114 and the capabilities of the agent 116. If an allocated item 114 requires a particular skill set, then allocation of that item may be limited to only those agents 116 that possess the skill set. For example, if the item is an email message written in Mandarin Chinese, then that item would be assigned to an agent 116 who can read and write Mandarin.

Management of the queue 106 and allocation of allocated items 114 to agents 116 may be controlled by a computing device 118 of a review agent 120 such as a manager or supervisor. The computing device 118 may be implemented as in a conventional type of computing device such as a desktop computer, laptop computer, tablet computer, smartphone, or the like. In some implementations, the computing device 118 may contain all or part of the functionality of the queue management system 108. The computing device 118 may include a queue management UI 122 which provides an interface for the review agent 120 to adjust the priority of items in the queue 106, to create views, and to allocate items to agents 116.

Changes made through the queue management UI 122 may be implemented in real time by directly modifying the prioritization and order of the items in the queue 106 without requiring further interaction of engineers, database programmers, or other users besides the review agent 120.

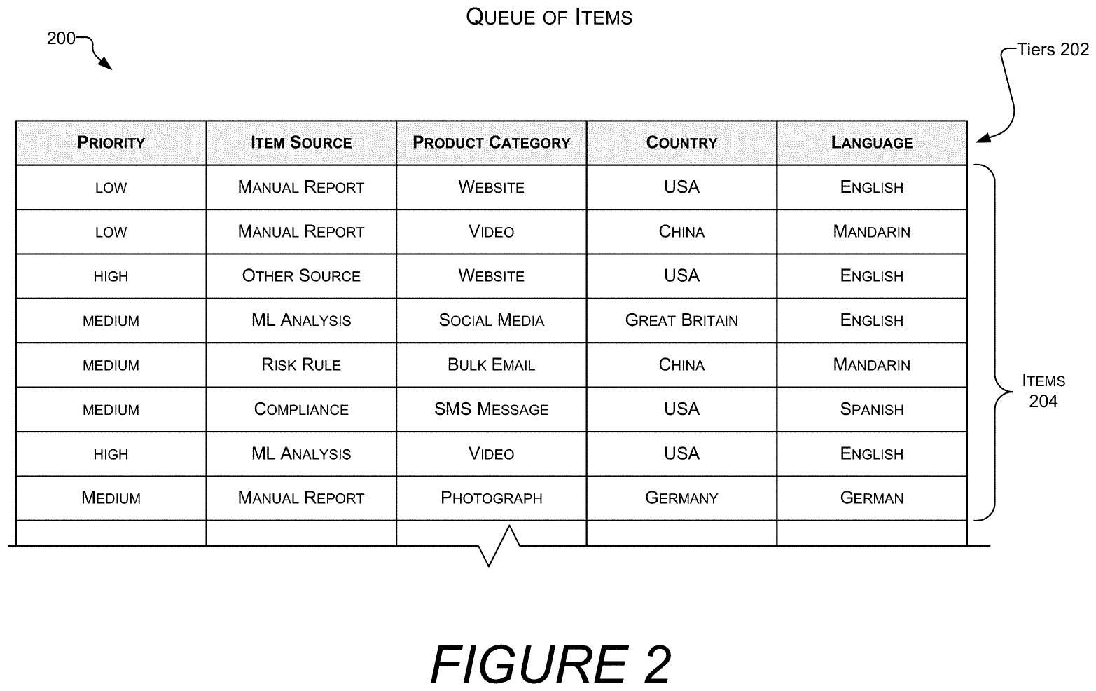

FIG. 2 shows an example of a queue of items illustrated as a table 200. The columns of the table 200 represent tiers 202. A tier 202 is an attribute of the items 204 that is used to prioritize the items 204 with respect to each other. In this example, the items 204 are tasks related to reviewing web content to determine if it violates a rule or policy. The tiers 202 shown in this table 200 include priority, item source (i.e., how the item was initially identified), product category (i.e., the category of web content such as a website or a video), country (i.e., the country in which the web content exists), and the language of the web content. The items 204 may additionally include attributes that are not used for prioritization, and thus, are not included as one of the tiers 202. For example, these various types of web content may include attributes such as file size which is not used to determine priority.

In this table 200, the items 204 are not necessarily ordered according to priority. Thus, the table 200 may simply represent a bag of items that have not yet been sorted or prioritized. The table 200 may include a large number of items 204 such as many millions of items for which sorting and prioritization based on multiple tiers 202 is a nontrivial task that can consume significant time and processing resources.

The ranking for some tier attributes may be fixed or “hardcoded.” For example, the tier attribute “Priority” may have a fixed ranking such that high-priority items are ranked above medium priority items which in turn are ranked above low priority items. Other tier attributes may have user-configurable rankings that can be changed such as via the queue management UI 122. For example, in one scenario review of items that are videos may be prioritized over review of items that are bulk emails and in a different scenario review of bulk emails may be more important than review of videos.

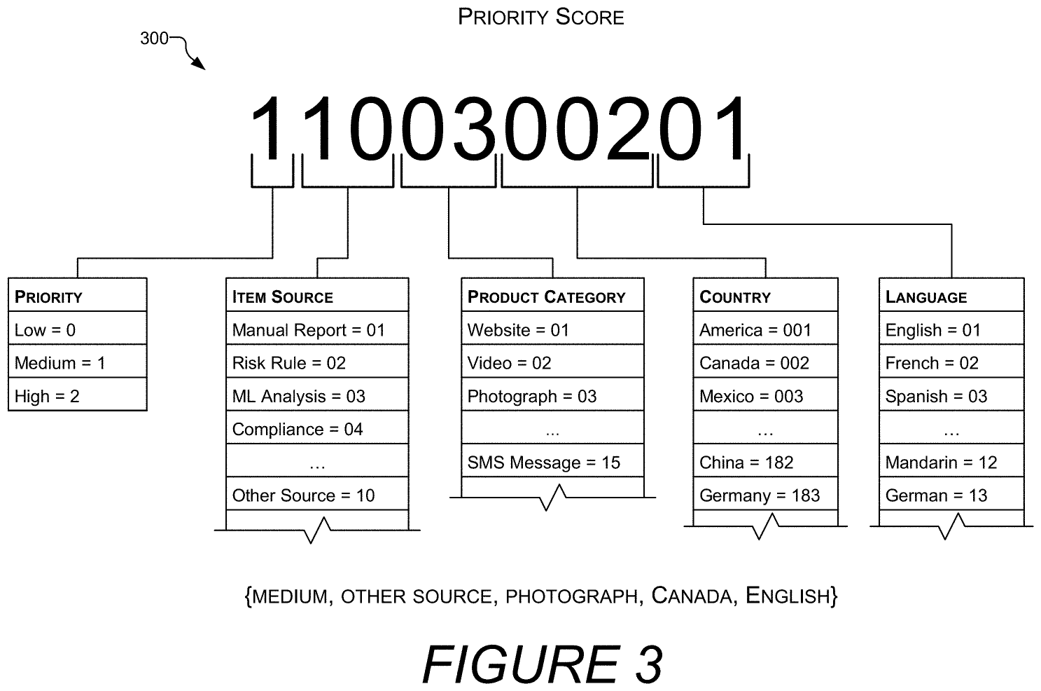

FIG. 3 shows an illustrative priority score 300. The priority score 300 is a number assigned to each item in a queue. The priority score 300 may be implemented as an integer such as a long integer. However, implementations of the priority score 300 are not limited to integers and may include other numeric representations such as decimal values.

By representing the priority ranking for items in the queue using a priority score 300 the relative priorities are represented in a format that is amenable for rapid sorting and reordering by computers using a comparison sorting technique such as quicksort, heapsort, shellsort, mergesort, introsort, or the like. When the priority score 300 is implemented as an integer, integer sorting is possible which allows for faster sorting using less processing power than comparison sorting. Integer sorting techniques including pigeonhole sort, counting sort, and radix sort.

The priority score 300 uses numerical values to represent the values of the tier attributes. The attribute of “priority” which may be low, medium, or high can be assigned the corresponding numerical values of 0, 1, 2. The correspondence assigns the highest valued number to the highest priority attribute within a tier. Thus, high-priority is assigned 2 while low priority is assigned 0. Similarly, the attribute within the other tiers such as “item source,” “product category,” “country,” and “language” are numbered according to the relative priority ranking. In this example, the item source of a Manual Report is ranked as 01 which has a lower ranking than identifying an item based on a risk rule that has the numerical value of 02. Thus, within each tier the ranking of attributes is reflected by the value of the numbers assigned to those attributes.

The number of digits allocated from the priority score 300 to represent a given tier depends on the number of different values for that tier. For example, the “priority” tier has only three possible values so it can be represented by a single digit. However, there are approximately 196 countries in the world so the tier “country” may take one of more than 100 values—but less than 1000 values—so it is represented by three digits in the priority score 300. Tiers for which there are between 10 and 99 possible different values may be represented by two-digit numbers.

Each of the numbers representing the value of a tier for a given item are concatenated to create the priority score 300. The order in which the numbers are concatenated determines the relative priority of the tiers. In this example, the most important tier for prioritization is the “priority” tier. Therefore, the value derived from this tier is placed at the front of the priority score 300. By sorting priority scores 300 according to numerical value the highest numbers will be given the highest priority and so all the priority scores starting with the number 2 (i.e., representing high-priority items) will sort higher than low or medium priority items regardless of the values of the subsequent tiers. Of course, the ordering of the tier values in the priority score may be reversed so that the least important tier value is listed first and the most important last. In which case the ranking would be reversed so that the lowest number priority score represents the most “important” or highest priority item.

In this example, the next most important tier for prioritization is “item source” followed by “product category,” “country,” and lastly “language.” Thus, the values for these respective tiers are concatenated in this order. The tier “language” being concatenated at the end of the priority score 300 has the smallest effect on the sorted order. For items which are otherwise equal, those items will be sorted relative to each other based on the language of the item with, in this example, German being ranked higher than Spanish which is ranked higher than English. These values are meaningful only in a relative sense not in terms of the specific numerical value. By way of explanation, assigning the language French the value of 02 is meaningful only in that 02 is smaller than the value assigned to Spanish which is 03 and larger than the value of 01 assigned English. The same relationship could be represented by assigning English the value 10, French the value 15, and Spanish the value of 20.

A change in the relative weight of the tiers in determining priority for the items would result in reordering and re-concatenation of the values that make up the priority score 300. For example, if the tier “language” was the most important characteristic following the “priority” then the value for the language would be concatenated merely following the value for the “priority.”

In this example, the priority score 300 represents a medium-priority item that was sourced from another source (e.g., not one of the specified sources), is a photograph from Canada and is written in or associated with the language English. All of these attributes of the item are encoded in the priority score 300 and the relative ranking of the tiers is also included in the priority score 300 based on the order in which the tier values are concatenated. This provides a single number (such as an integer) for each item in the queue that allows for efficient and rapid sorting. It also creates a structure in which changes in relative tier ranking as well as in relative ranking of attributes of a tier can be reflected in a modified priority score 300.

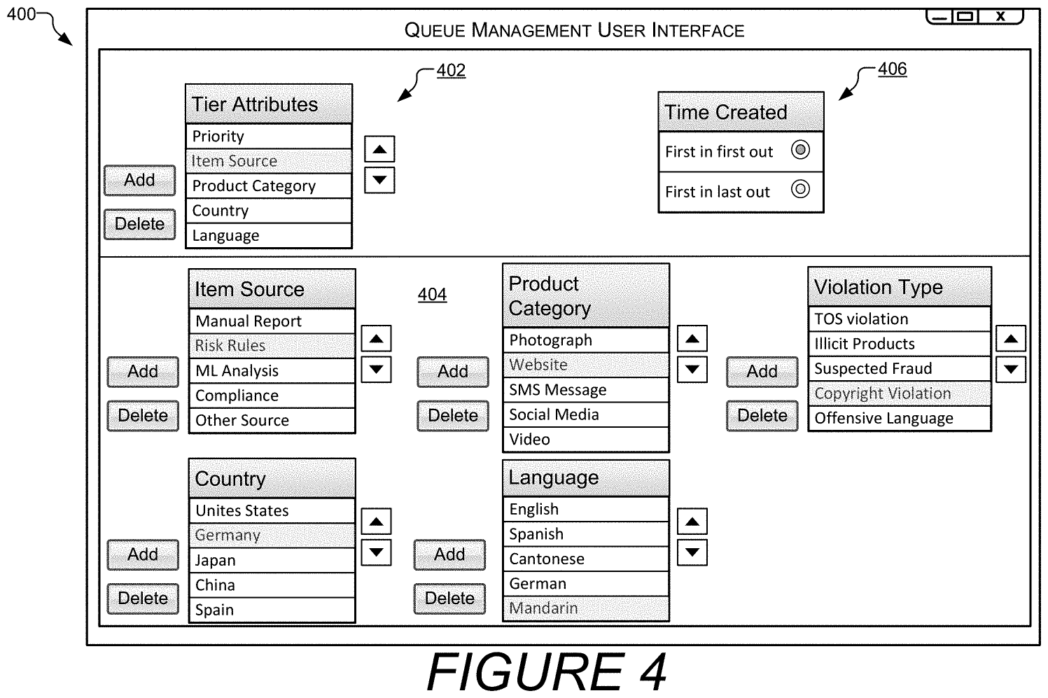

FIG. 4 shows an example of a queue management UI 400. The queue management UI 400 is one example of a UI that may be presented by the queue management UI 122 to the review agent 120 for managing the queue of items. The queue management UI 400 includes a first UI element 402 for selecting and ranking the tier attributes. Tier attributes selected for inclusion in this list are used for prioritization of items. In one example implementation, this UI element 402 may be an ordered list in which the ordering of the items in the list may be changed. The available tier attributes are listed, which in this example, include “priority,” “item source,” “product category,” “country,” and “language.” Any of the tier attributes included in this ordered list may be removed such as by clicking a delete button. Additional features of the items may be added as tier attributes by clicking an add button and selecting one or more features that are not currently included in the list of tier attributes. Recall that the items may be associated with a number of features and only some of those features may be used as tier attributes for determining a rank or prioritization of the items.

Use of the up and down arrows to the right of this UI element 402 is one technique for adjusting the order of the tier attributes with respect to each other. For example, the tier attributes listed at the top of this list (e.g., “priority”) may be the most important attribute for ranking items. The changing the ranking of the tier attributes changes the order in which the tier attribute values are concatenated in the priority score 300. For example, moving the priority of the “item source” tier down below that of “product category” using this UI element 402 would result in the digits corresponding to the “product category” moved behind the digit corresponding to “priority” in the priority score 300 and the digits corresponding to “item source” would be moved so that they follow the digits corresponding to the “product category.” Ordering the relative priority of the tier attributes using this UI element 402 modifies the default priority for the queue.

The lower portion of the queue management UI 400 includes a value prioritization region 404 that shows multiple UI elements for adjusting the relative priority of the features within the tier attributes. Each of the UI elements may, in an implementation, be presented as ordered lists of values for a given tier attribute. Each of the tier attributes shown in the value prioritization region 404 includes a number of values for that attribute. For example, the “item source” tier includes the values of “manual report,” “risk rules,” “machine learning (ML) analysis,” “compliance,” and “other source.” Each of these values represents a different type of source for the item such as whether the item was identified as part of a compliance procedure or by machine learning. These values are merely illustrative and different tier attributes will take different values. These values for the “item source” tier may be prioritized with respect to each other by using up and down arrows or other techniques for interacting with the queue management UI 400. For each of the respective tier attributes, new values may be added activating and add button and existing values may be removed with a delete button. Thus, the value prioritization region 404 provides a dynamic interface for a user such as the review agent 120 to adjust the ranking of values within each tier. Some tier attributes that are not manually adjustable, such as “priority,” are not shown in the value prioritization region 404 because there is no ability to change the relative ranking of values for that tier.

The value prioritization region 404 shows tier item UI elements that list the possible values for a tier. If there are a large number of values for a tier it may be inconvenient to scroll through a long list in order to change the priority of the values. For example, with the tier attribute of “country” there may be 196 values in the list. A tier attribute with a large number of values, like countries, or with a continuously varying value such as time or price may be mapped to a smaller number of values by dividing the values into buckets. The buckets may be based on logical divisions that can be mapped to different levels of priority. For example, countries may be grouped into buckets based on geographical regions such as North America (Canada, U.S.A., and Mexico), APAC (China, Korea, etc.), Europe, and so on. Dollar amount may be segmented into ranges such as less than $10, $10-$100, $100-$1000, and above $1000, for reasons including but not limited to such segments representing specific business significance (e.g., transaction risk).

The queue management UI 400 may also include a UI element 406 for sorting based on a continuously variable tier attribute. In this example, the continuously variable tier attribute is a time of creation for the items. The time of creation may be used as the final, or lowest priority, tier attribute for sorting the items. Thus, after the items have been sorted by all of the tier attributes identified in the UI element 402, they are further sorted based on time of creation. Thus, the continuously variable tier attribute (e.g., timestamp, dollar amount, risk score, etc.) may be used as a secondary sort parameter or a “tiebreaker” to determine a sorting order for two items that would otherwise have the same priority score.

For example, after a priority score has been determined based on the other tier attributes the queue can be sorted as represented by the following logic: SELECT*FROM ItemQueue ORDER by PriorityScore DESC, TimeCreated. This logic illustrates a first in first out strategy for sorting items with the same priority score. As shown in that UI element 406, the continuous variable may be sorted from high-to-low or low-to-high, such as in the case of time, first-in-first-out or first-in-last-out.

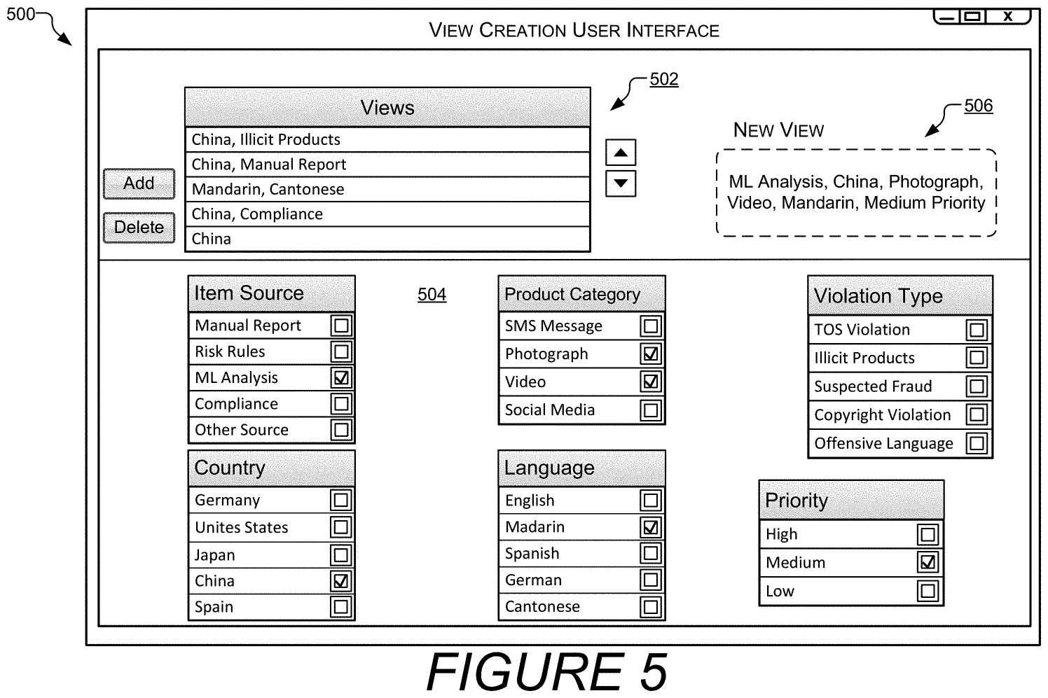

FIG. 5 shows an example of a view creation UI 500. The review agent 120 may use this or a similar UI to create one or more views for the agents 116. A view is a specific segment of the queue for a particular agent or group of agents (i.e., a team). A view may be created based on agent skill sets, operation priorities, or other needs that require segmenting, grouping, or isolating particular types of items and prioritizing these segments of the queue.

A view list 502 may include a list of current views that can be ordered in a priority ranking using up and down arrows or another type of UI interaction. “Add” and “delete” buttons may be used to create additional views or remove views from the view list 502. Attribute picking region 504 shows multiple tier attributes and values for those tier attributes that may be selected as tier-attribute filters to create a view. The tier attributes and respective values shown in the attribute picking region 504 may be the same as the tier attributes and values shown in the value prioritization region 404 of FIG. 4. However, there may be additional tier attributes shown in attribute picking region 504 that are not used for generating a priority score (e.g., language may not be used for prioritization but it may be used to create views that assign tasks to agents with the appropriate language skills) or tier attributes that are not customizable (e.g., “priority,” compliance with a service level agreement (SLA), etc.) they provide a basis for generated in view but have their facts on the ranking of the overall queue “built-in” and not amenable to change through an end-user facing interface.

A view is created, for example in response to activating the “add” button, by selecting values from one or more of the tier attributes shown in the attribute picking region 504. At a minimum, a view requires only one value from one tier attribute. For example, a view could be based on a country and include all the tasks that originate in that country, China for example, without any other filtering limitation. Views may also be generated from the items in the queue based on values for multiple tier attributes. For example, a view could be limited to those items that originate in China and flagged with the violation type of illicit products. Moreover, a view may include multiple values from a single tier attribute such as a view that includes all the items that have a value for Language as either Mandarin or Cantonese.

The activated checkboxes shown in the attribute picking region 504 illustrate the creation of an example new view 506. This new view 506 includes those items which the item source is machine learning analysis, the country is China, the product is there a photograph or a video, the language is Mandarin, and the priority is medium. Note that in this example new view 506 does not include a limitation on the tier value of “Violation Type” so items of all violation types are included.

Use of the view creation UI 500 may provide a convenient interface for interacting with a more complex set of tools to create subsets from the queue. For example, the underlying actions implemented by the view creation UI 500 may be represented in SQL such as for creating a view of photographs from China: SELECT*FROM ItemQueue WHERE language=“Chinese” AND ProductType=“Photograph”. Using the view creation UI 500 to create a view that shows items in the Mandarin or Cantonese languages which represent the Violation Type of illicit products may be converted to a command such as: SELECT*FROM ItemQueue WHERE language IN (“Mandarin”, “Cantonese”) AND Violation Type=“Illicit_Products”. As a further example, a view based on a continuous attribute such as time may be generated to show items that have been in the queue more than three days with logic such as: SELECT*FROM ItemQueue WHERE CurrentTime−TimeQueued>=3 days.

Creation of a view does not change the ordering or prioritization of the queue. It does not change how the priority scores for items in the queue are calculated. View creation may be performed dynamically in response to changing needs or conditions. The view creation UI 500 provides an interface that readily shows user options for creating views as well as the views that currently exist. The view list 502 may order those views based on priority for a specific agent or team. In this example view creation UI 500, the current list of views for the agent has “China, illicit products” as the first priority view followed by “China, manual report” as the next most important view with the view for all items having to do with China as the lowest priority. This sorting of views is used to determine which item or items are surfaced to the agent for the agent act on.

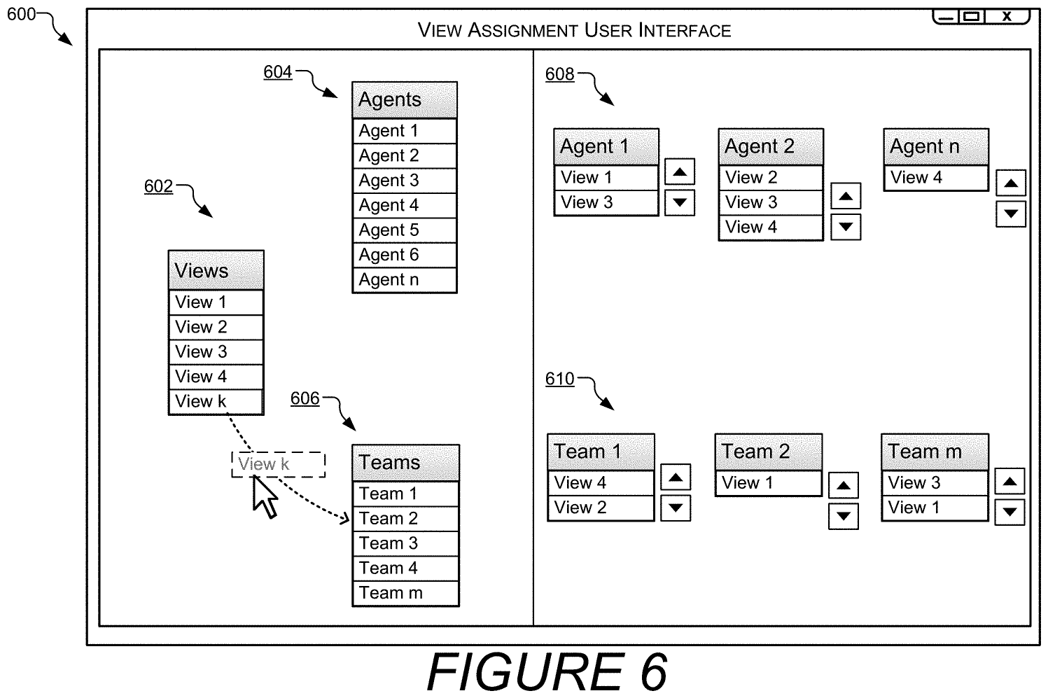

FIG. 6 shows an example of a view assignment UI 600. This view assignment UI 600 provides further details about how view priority may be implemented and how views are assigned to one or more different entities. Entities include both agents which are individual workers that address items in a queue and teams that are groups of agents. The view assignment UI 600 also includes a list of available agents 604 and a list of available teams 606. Addressing an item in the queue may include reviewing the item, responding to the item, evaluating the item, answering the item, or another type of activity based on the nature and type of item. A given person, a worker, may have views assigned to him or her both as an individual agent and as a member of a team.

The view assignment UI 600 shows a number of different existing views 602 that are available to be assigned. In this example, the views 602 are identified as View 1 through View k. Any number of views may be included in this list and the views may have descriptive titles such as the views shown in the view list 502 of FIG. 5. A view may be assigned to an entity by associating that view with the entity. For example, the view “view k” may be associated with Team 2 by dragging the view over the name of the team. This may be done repeatedly to associate a given view such as “view k” with multiple teams and or agents. Moreover, multiple different views may be associated with the same entity. Thus, the view assignment UI 600 supports a many-to-many mapping of views to entities.

Although this illustrative view assignment UI 600 shows a select-and-drag action as associating a view with an entity, any types of UI interactions may be used. This view assignment UI 600, as well as any of the other UIs described herein, may be implemented as a command-line UI or text-based UI instead of or in addition to a graphical user interface (GUI).

The view(s) assigned to one or agents are displayed in an agent view list 608. The agent view list 608 shows an ordered list of views assigned to an individual agent. The priority of the views for a given agent may be adjusted using this UI through an interface element such as, but not limited to, up and down arrows.

For example, Agent 2 is assigned View 2, View 3, and View 4. A view shown higher in the list may indicate a higher priority as compared to a view appearing lower in the list. The order of the views in terms of priority for Agent 2 is thus View 2 as the highest priority, then View 3, and View 4 as the lowest priority. The ordering of views may be changed such as, for example, by making View 4 higher priority than View 3 for Agent 2.

The priority of a view for an entity (i.e., an agent or team) determines which items are prioritized for assignment to that entity. Thus, for Agent 1, for example, items from View 1 will be presented first until items from that view are all completed and then items from View 3 will be presented. Depending on the number of items included in a view and the length of time required for an agent to address each item, the agent may not receive items from a second or lower ranked view. However, the review agent 120 or manager may address this at least in part by making a low-priority view for a first agent a higher priority view for a second agent. For example, while View 4 is the third priority view for Agent 2, Agent n has View 4 as his or her only view. Thus, even if Agent 2 is not able to address items included in View 4, at least some of those items will be addressed by Agent n.

Alternatively, the list of items available to an entity may include items from all of the assigned views mixed together and sorted according to the individual priority scores of those items. Thus, Agent 1 for example, may be assigned items to work on items from View 1 and View 3 based on the priority ranking of those items with respect to each other. For example, View 1 may include items filtered based on Violation Type that includes items flagged as illicit products and View 2 may include items filtered based on Item Source that has items identified according to a set of risk rules. Rather than presenting Agent 1 all the items that are labeled as illicit products first and then presenting the items from the item source of risk rules second, the highest priority items from both groups may be presented before lower priority items. For example, Agent 1 may be assigned all of the high-priority items for that are have illicit products as their Violation Type and all the high-priority items that have the Item Source of risk rules first before receiving the medium-priority items from either group.

A team view list 610 shows the views and relative priority of those views assigned to each of multiple separate teams. As with the priority of views for agents, the priority of views for a team may be shown in an ordered list in which the ordering of entries can be adjusted using up and down arrows or other user interface interaction.

Assignment of a view to an entity may be based on attributes of the entity (e.g., skill sets of an agent or team) or on a tier attribute used to define the view. For example, a view may be defined by language and that view may be assigned to agents or teams with members who are proficient in that language. This is an example of assigning a view based on an attribute of the entity. A view may be defined to include all the items that are identified as high-priority for the tier attribute of “priority.” This view may be assigned to an entity not based on any attribute of the entity but on the high-priority characteristic of the items in the view. This is an example of an assignment of a view based on a tier attribute used to create the view. Views may also be assigned to entities based on the role or work assignment of the entity. For example, a team whose job is to review social media may be assigned a view based on the Product Category value of social media.

Change of a value for an item in the queue may cause the items membership in one or views to be automatically updated without further user interaction. For example, if a given item is changed from high-priority to medium-priority, that item may be removed from the view that is filtered on high-priority value for that “priority” tier. Similarly, items may be added to a view based on a change in a value for a tier attribute of that item. Additionally, the incoming items 102 may be added to a view by the queue management system 108 as the items are received and processed. Thus, a view represents a dynamic logic grouping of items from the queue that may have different items included in the view at different times but retain the same definition for the view. Moreover, the ordering of items within a given view is the same ordering of those items in the larger queue. Thus, a view does not change the ordering of individual items it merely identifies a subset of the items from the queue based on the characteristics of those items.

Moreover, the views as well as the priority of the views assigned to an entity are not static but may change based upon input from the review agent 120 or another user or based on pre-defined rules. For example, the views and priority views assigned to an entity may vary based on time such as the date, the day of the week, the day of the month, month, and the like. For example, Team 1 in this view assignment UI 600 has view 4 prioritized above view 2. If view 4 has a large number of items and more items included in view 4 are continually added to the queue, Team 1 may never complete all the items in view 4. In this scenario, the items in view 2 may be unaddressed. To prevent this, the prioritization of views may be altered or rotated based on time such as switching the priority ranking of view 4 in view 2 every other day. Thus, tomorrow Team 1 would have view 2 listed as first priority and view 4 listed as the second priority view.

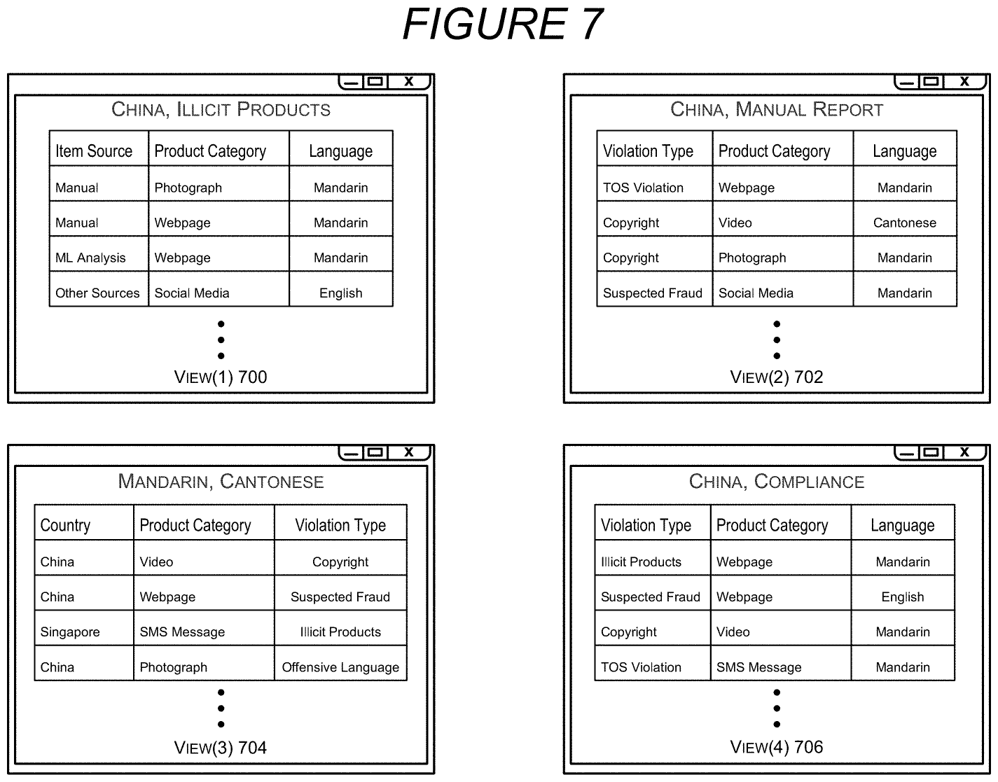

FIG. 7 shows four examples of views that represent logic subsets of the items in the queue. Although view(1) 700, view(2) 702, view(3) 704, and view(4) 706 are shown as tables, the views themselves may never be displayed in a UI. The various views may simply be data structures that are created through interaction with the UI such as the view creation UI 500 and that are used to identify items for assigning to entities. However, the contents of any given view may be shown to the review agent 120 or another user as a table or other UI presentation.

View(1) 700 shows a logic subset of items that all have the tier features of Country as China and Violation Type as illicit products. Within this view(1) 700 each of included items has a priority order relative to each other based on other characteristics of those items (i.e., because China and illicit products are by definition the same for every item in this view those characteristics are not useful for sorting within the view). When displayed as a table or other UI element, the tier features used to define the view may be omitted.

View(2) 702 shows a logic subset of items that are filtered based on the Country as China and the Item Source as manual report. Thus, all of the items in this view(2) 702 are items that came from China and were identified through manual reporting.

View(3) 704 shows a logic subset of items that have the tier feature of Language as Mandarin or Cantonese. Thus, this view is appropriate for assignment to an entity that has proficiency with these languages.

View(4) 706 shows a logic subset of items that have the tier feature of country as China and the Item Source as compliance. This view(4) 706 is similar to view(2) 702 in that both views are filtered based on the same country, China, and an Item Source. Assigning both view(2) 702 and view(4) 706 to the same entity would give that entity the items from China that were identified through manual reporting and compliance procedures. Keeping these two views separate makes it possible to adjust the relative priority of items based on how the items were identified (i.e., manual report or compliance) by adjusting the priority of these two views for the entity. As discussed in the description of FIG. 6, adjusting the priority of multiple views with respect to an entity may be performed through use of up and down arrows or another UI element.

Use of views provides a powerful way to adjust the relative priority of items in the queue in real-time at individual entity level, without changing the default ordering or prioritization of the queue itself, or the structure of the queue. This is a faster and more flexible way to adjust the priority of items because the use of views is equivalent of dividing a large queue into an unlimited number of ordered sub-queues that are tailored made for each individual entities in real-time, thus maximize the overall productivity of the business operation. Views may be used to implement priority changes that occur frequently while changes to the default priority of the queue (e.g., as shown in the queue management UI 400) may be used for less frequent changes.

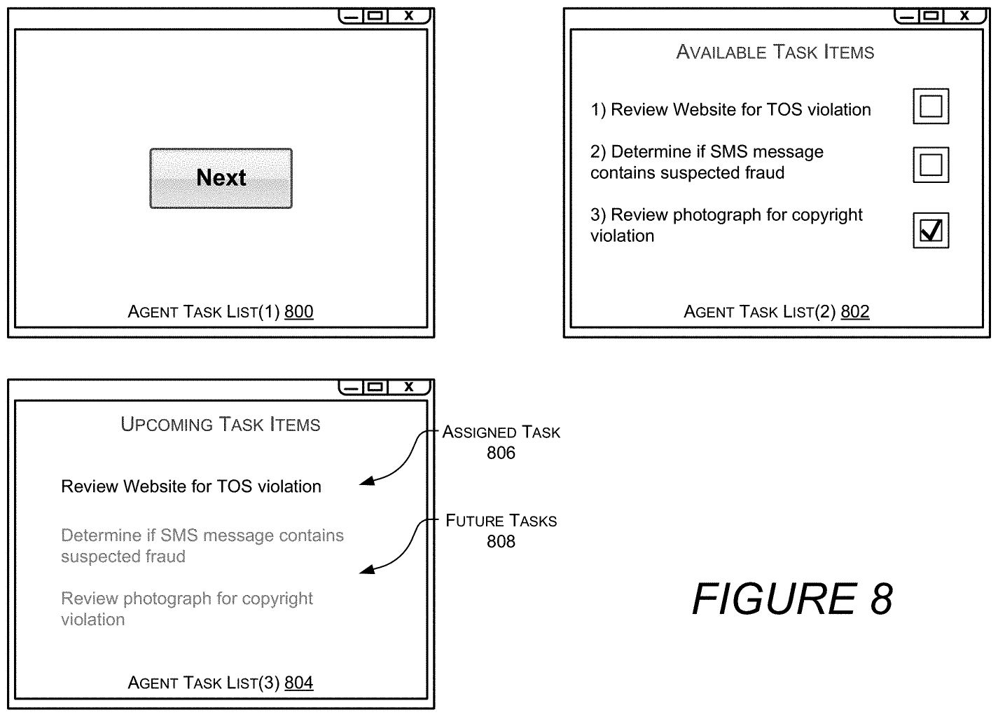

FIG. 8 shows four examples of agent task lists presenting one or more available tasks to an agent. After items in the queue are prioritized and one or more views applied, if used, allocated items 114 are provided to agents 116 or other entities as shown in FIG. 1. Generally, an entity only works on one item at a time. Thus, the queue management system 108 identify the single highest-priority item from the queue and assign that item to an entity. As entities become available to accept items, this process repeats and each time it is the highest-priority item at that point in time which is assigned out from the queue. Additionally, if views are used then the view(s) function to assign the highest-priority item in the queue to the entity best qualified to address that item. For example, an agent that cannot read Mandarin may not receive the task of reviewing an SMS message written Mandarin even if that is currently the highest-priority item in the queue.

One implementation of an agent task list(1) 800 shows a single “next” button. The “next” button may be replaced with any user interface element that pulls or surfaces an item on demand for the agent. With this illustrative type of agent task list(1) 800 the agent will click on the “next” button and an item is dynamically pulled from the queue based on the prioritized view list assigned to that agent and the default priority score. The agent may not know what item will be assigned until he or she activates the “next” button or similar user interface element. Thus, the list of potential items for the agent to work on is not presented to the agent. In fact, the agent may not even necessarily be aware of which view or views are applied to modify the items presented to him or her. The results of clicking the “next” button may be different for different agents based on the views assigned to those agents.

When an item is assigned from the queue to an agent, such as one of the allocated items 114 been assigned to one of the agents 116 shown in FIG. 1, that item is removed from the queue. The precise timing of activating the “next” button may be used to resolve race conditions between two agents that would otherwise both be assigned the same item. Thus, whichever agent activates the “next” button, or otherwise requested an item from the queue, first received the item and the agent that was later in time receives the next highest-ranked item from the queue. In instances in which it is difficult or impossible to determine which agent indicated a request to pull an item first, the system may assign the item randomly.

A second example of an agent task list(2) 802 shows a number of available task items for the agent to select. In this UI illustration, the agent may select one of three task items to work on based on a brief description of the task item and by selecting a checkbox or other UI element to indicate one of the multiple items. Thus, the agent task list(2) 802 may provide the agent with the choice between the top-priority two, three, four, five, or more items from the queue. As discussed above, the items included in this agent task list(2) 802 may be determined based in part on one or views assigned to the agent. Also, as discussed above, the views may be assigned to the agent individually or based on the agent's membership in a team that is assigned one or views.

Another illustrative implementation of an agent task list(3) 804 may show upcoming task items including a currently assigned task 806 and future tasks 808 that are not yet released for the agent to work on. In a system with multiple agents pulling items from the queue, the future tasks 808 may change if one of those tasks is assigned to another agent while this agent is still working on the currently assigned the task 806. Thus, the list of upcoming tasks for an agent whether presented in a UI such as the agent task list(3) 804 or hidden from the agent is dynamic and will change based on the task available in the queue, any applied views, and activities of other agents withdrawing tasks from the queue.

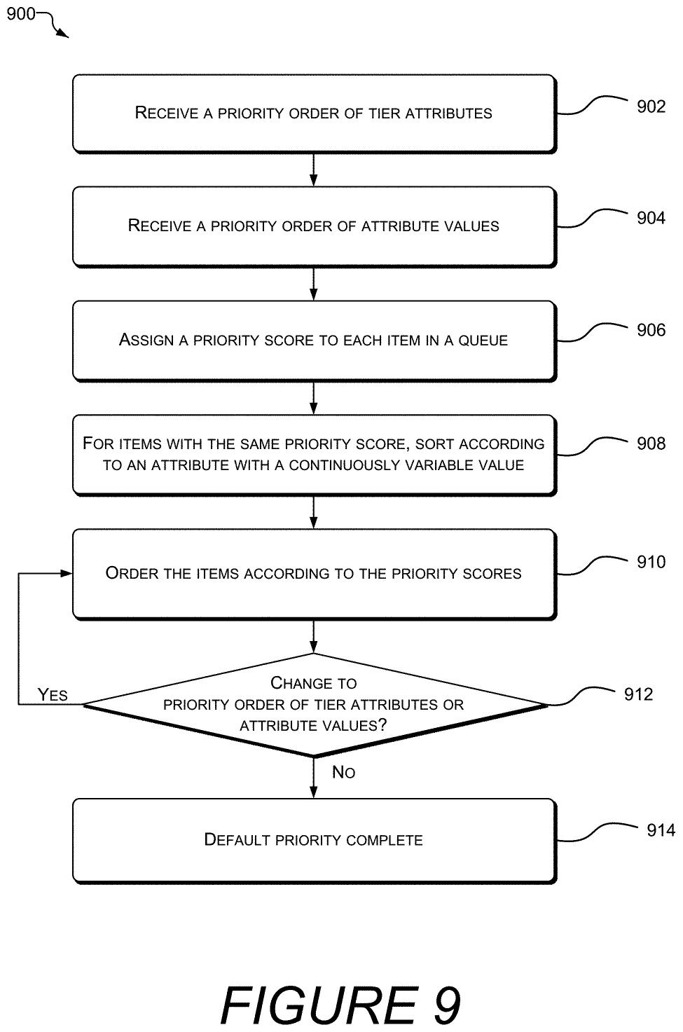

FIG. 9 shows an illustrative method 900 ordering items in a queue. Ordering items in the queue may establish a default priority order that ranks every item in the queue with respect to the other items in the queue.

At 902, a priority order tier attributes may be received. The priority order of tier attributes may be received, for example, through interaction with a UI such as the queue management UI 400 specifically by adjusting a list of tier attributes with the UI element 402. Thus, the priority order of tier attributes may indicate, for example, that Item Source is a higher priority attribute than Product Category.

At 904, a priority order of attribute values is received. The priority order of attribute values may be received, for example, from interaction with a UI such as the queue management UI 400 through the value prioritization region 404. Each of the attribute values may be mapped to a numeric value.

For example, a tier attribute of Item Source may have a value “manual report” mapped to the numeric value 20 and the value “risk rules” mapped to the value 15. The relative magnitude of the numeric values indicates the priority order of the attribute values. In this example, larger numeric values may correlate with higher priority so the numeric value of 20 assigned to “manual report” indicates that this attribute value is a higher priority than risk rules which is mapped to the smaller number 15. The relative magnitude of the numeric values, not the values themselves conveys the priority order. Thus, having “manual report” assigned the numeric value of 7 and “risk rules” assigned the numeric value of 6 also denotes that “manual report” is a higher priority than “risk rules.”

Furthermore, if one of the attribute values is continuously variable, the continuously variable value may be binned into discrete bins each associated with a single numeric value. For example, if the continuously variable values is price and higher prices are prioritized as more important than lower prices, prices of $10,000 and over may be placed in a bin with the value 10, prices of $9,000-$9,999 may be places in a bin with the value 09, prices of $8,000-$8,999 may be placed in a bin with the value 08, prices of $7,000-$7,999 may be placed in a bin with the value 07, prices of $6,000-$6,999 may be placed in a bin with the value 06, prices of $5,000-$5,999 may be placed in a bin with the value 05, prices of $4,000-$4,999 may be placed in a bin with the value 04, prices of $3,000-$3,999 may be placed in a bin with the value 03, prices of $2,000-$2,999 may be placed in a bin with the value 02, prices of $1,000-$1,999 may be placed in a bin with the value 01, and prices under $1,000 may be places in a bin with the value 00.

At 906, a priority score is assigned to each item in the queue based on the attributes and attribute values associated with that item and on the priority order of tier attributes from 902 and the priority order of attribute values from 904. The priority score may be created in a manner that is the same or similar to the priority score 300 shown in FIG. 3. Thus, the priority score may be created by concatenating numeric values for the attribute values according to the priority order of the tier attributes. The priority score may be created indirectly from inputs provided to a UI such as the queue management UI 400 without presenting the priority score for any, or all, queue items to a user.

At 908, for items with the same priority score, the items may be sorted according to an attribute that has a continuously variable value (e.g., time, cost, risk score, etc.). The sorting may be done with any conventional technique for sorting numbers. The sort order may be from highest-to-lowest or from lowest-to-highest.

At 910, items in the queue are ordered according to their priority scores. Larger priority scores may correspond to priority in the queue or alternatively may correspond to lower priority. The ordering may be performed by any technique for ordering numbers such as an efficient integer sorting technique.

At 912, a change to the priority order of tier attributes (i.e., which attributes are more important than other attributes) or a change to the priority order of attribute values may be received. The change may be based on input provided to a UI such as queue management UI 400 that changes the order of the tier attributes list by use of a UI element 402 or changes the ordering of values in one of the lists included in the value prioritization region 404. For example, the input may be a selection of an item in a list and activation of an up or down arrow moving the position of that item higher or lower in the list. This change results in updating of the priority score for items in the queue.

The updating may result in a change in the prioritization of the items in the queue. This re-ordering of the queue items may be initiated automatically when either the priority order of tier attributes or the priority order of attribute values for a tier is changed. The updating may also occur in real-time without any delay imposed beyond that necessary for sorting the new priority scores.

If a change is received, method 900 proceeds along the “yes” path and returns to 910 where the items in the queue are (re)ordered according to the priority scores. If there are no changes to either the priority order of the tier attributes or attribute values, method 900 proceeds along the “no” path.

At 914, the default priority is complete. The default priority of the items in the queue will remain even if one or more logic subsets of the items in the queue are defined to create one or more views. Moreover, as additional items are added to the queue those items will be placed in the queue according to their attributes and the default priority without changing the default priority (even though the identity of the items included in the queue changes). Removal of items from the queue such as by allocating an item to an agent also changes the specific items in the queue but does not change the default priority.

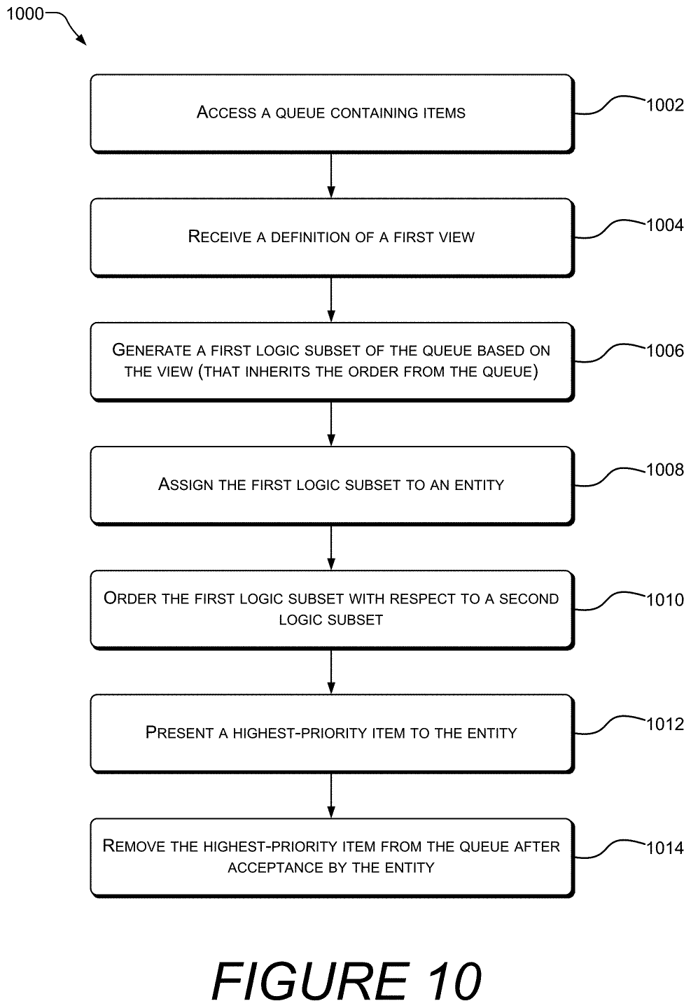

FIG. 10 shows illustrative method 1000 for managing a queue using logic subsets represented as views. The operations in method 1000 may be implemented by the view creation UI 500 and/or the view assignment UI 600.

At 1002, a queue containing a plurality of items is accessed. A default priority ordering may be defined for the items in the queue. The default priority ordering may be defined by a technique such as method 900 described above in which the plurality of items in the queue are ordered according to a default priority based on tier attributes and attribute values. For example, the default priority may be implemented by using a priority order assigned to the attribute values and a priority order assigned to the tier attributes to generate a single numeric score (e.g., integer value) for each of the plurality of items in the queue. Alternatively, the queue may not have a default priority ordering and may be ordered randomly, by the time items entered the queue (temporal order), or by alphabetic order, or another arbitrary order.

At 1004, a definition of a first view comprising a first tier-attribute filter is received. The definition may indicate the first tier-attribute that all items in the first view may have. For example, the tier-attribute may be origination of the item in the country China, so all the items in a view so defined will have China as the value for a Country attribute tier.

At 1006, a first logic subset of the queue is generated based on the first view defined at 1004. The items in this logic subset may inherit their priority order from a default priority of the queue based on tier attributes and attribute values.

At 1008, the first logic subset of the queue is assigned to an entity. The entity may be an agent or a team of agents.

At 1010, the first logic subset is ordered with respect to a second logic subset that is also assigned to the entity. Thus, the entity has at least two assigned logic subsets including items from the queue assigned to him, her, or it. Ordering the logic subsets with respect to each other indicates which subset of items the entity should work on first. For example, if the second logic subset is given a higher priority than the first logic subset, then the entity may be assigned items from the second logic subset until that logic subset is empty before being assigned any items from the first logic subset.

At 1012, a highest-priority item is presented to the entity based on the order of the first logic subset and the second logic subset. The presentation to the end-user that is the entity may be interactive or dynamic such as illustrated by the agent task lists 800, 802, 804, and 810 shown in FIG. 8.

At 1014, the highest-priority item is removed from the queue after acceptance by the entity. Once the entity accepts the item to work on, such as by clicking a button or otherwise interacting with one of the agent task lists 800, 802, 804, and 810, the item will be removed from the queue so that no other agents will work on the same item. If the agent is unable to complete the item, it may be returned to the queue.

The previous methods disclose illustrative techniques for implementing features of this disclosure. It also should be understood that the illustrated methods can end at any time and need not be performed in their entireties. Some or all operations of the methods, and/or substantially equivalent operations, can be performed by execution of computer-readable instructions included on a computer-readable storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

For example, the operations of the methods 900 or 1000 can be implemented by dynamically linked libraries (“DLLs”), statically linked libraries, functionality produced by an application programming interface (“API”), a compiled program, an interpreted program, a script, a network service or site, or any other executable set of instructions. Data can be stored in a data structure in one or more memory components. Data can be retrieved from the data structure by addressing links or references to the data structure.

Although the following illustration may refer to the components of the FIGURES, it can be appreciated that the operations of the methods 900 or 1000 may be also implemented in many other ways. For example, the methods 900 or 1000 may be implemented, at least in part, by a processor of another remote computer, processor or circuit. In addition, one or more of the operations of the methods 900 or 1000 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

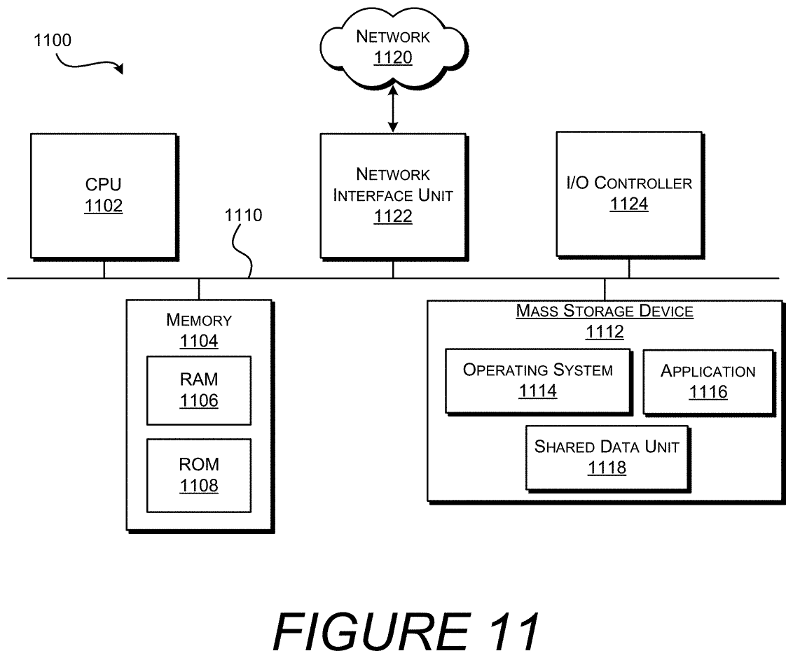

FIG. 11 shows details of an example computer architecture 1100 for a computer, such as the computing device 118 or the queue management system 108 shown in FIG. 1, capable of executing the program components described herein. Thus, the computer architecture 1100 illustrated in FIG. 11 illustrates an architecture for a server computer, a mobile phone, a personal digital assistant (PDA), a smartphone, a desktop computer, a netbook computer, a tablet computer, and/or a laptop computer. The computer architecture 1100 may be utilized to execute any aspects of the software components presented herein.

The computer architecture 1100 illustrated in FIG. 11 includes a central processing unit 1102 (“CPU”), a system memory 1104, including a random-access memory 1106 (“RAM”) and a read-only memory (“ROM”) 1108, and a system bus 1110 that couples the memory 1104 to the CPU 1102. The CPU 1102 may be implemented as any type of processor or processing units including single and multicore configurations. A basic input/output system (BIOS) containing the basic routines that help to transfer information between elements within the computer architecture 1100, such as during startup, is stored in the ROM 1108. The computer architecture 1100 further includes a mass storage device 1112 for storing an operating system 1114, an application 1116 such as a queue management application, a shared data unit 1118 containing data such as the queue 106, and other data described herein.

The mass storage device 1112 is connected to the CPU 1102 through a mass storage controller (not shown) connected to the bus 1110. The mass storage device 1112 and its associated computer-readable media provide non-volatile storage for the computer architecture 1100. Although the description of computer-readable media contained herein refers to a mass storage device, such as a solid-state drive, a hard disk or a CD-ROM drive, it should be appreciated by those skilled in the art that computer-readable media can be any available computer-readable storage media or communication media that can be accessed by the computer architecture 1100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information, and which can be accessed by the computer architecture 1100. For purposes of the claims, the phrase “computer-readable storage medium” does not include waves, signals, and/or other transitory and/or intangible communication media, per se.

According to various configurations, the computer architecture 1100 may operate in a networked environment using logical connections to remote computers through a network 1120. The computer architecture 1100 may connect to the network 1120 through a network interface unit 1122 connected to the bus 1110. The computer architecture 1100 also may include an input/output controller 1124 for receiving and processing input from a number of other devices, including a keyboard, mouse, touch, or electronic stylus or pen. Similarly, the input/output controller 1124 may provide output to a display screen, a printer, or another type of output device. The output may include any of the user interfaces shown in FIGS. 4-8.

It should be appreciated that the software components described herein may, when loaded into the CPU 1102 and executed, transform the CPU 1102 and the overall computer architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1100 in order to store and execute the software components presented herein. It also should be appreciated that the computer architecture 1100 may include other types of computing devices, including hand-held computers, embedded computer systems, personal digital assistants, and other types of computing devices known to those skilled in the art. It is also contemplated that the computer architecture 1100 may not include all the components shown in FIG. 11, may include other components that are not explicitly shown in FIG. 11, or may utilize an architecture completely different than that shown in FIG. 11.

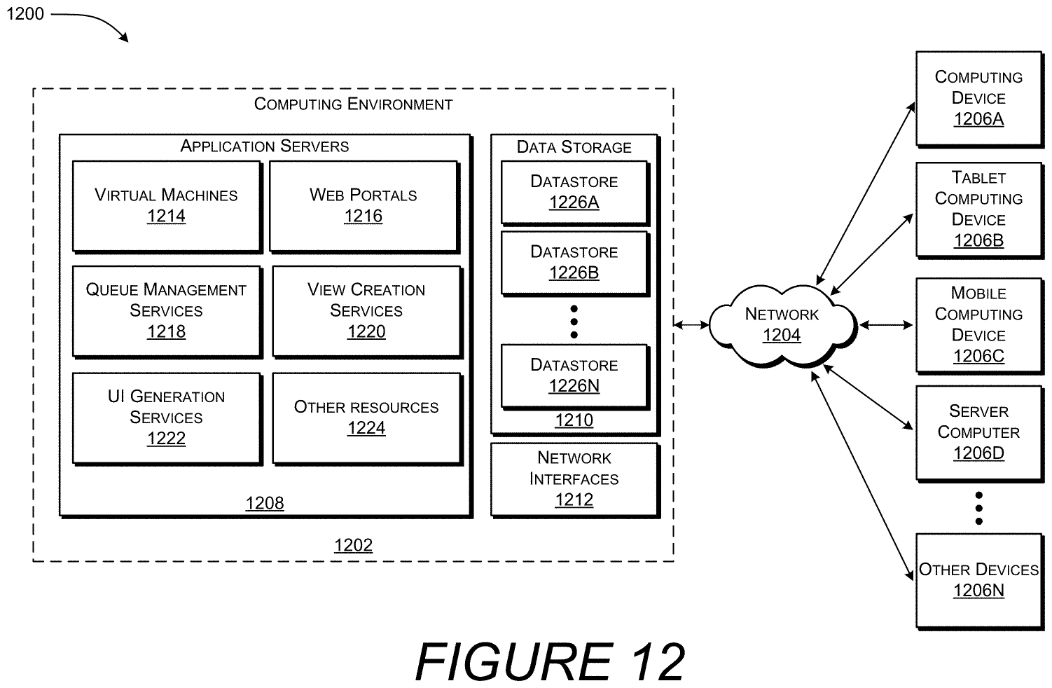

FIG. 12 depicts an illustrative distributed computing environment 1200 capable of executing the software components described herein. Thus, the distributed computing environment 1200 illustrated in FIG. 12 can be utilized to execute any aspects of the software components presented herein.

According to various implementations, the distributed computing environment 1200 includes a computing environment 1202 operating on, in communication with, or as part of the network 1204. One or more client devices 1206A-1206N (hereinafter referred to collectively and/or generically as “clients 1206” and also referred to herein as computing devices 1206) can communicate with the computing environment 1202 via the network 1204.

In one illustrated configuration, the clients 1206 include a computing device 1206A such as a laptop computer, a desktop computer, or other computing device; a slate or tablet computing device (“tablet computing device”) 1206B; a mobile computing device 1206C such as a mobile telephone, a smartphone, or other mobile computing device; a server computer 1206D; and/or other devices 1206N. It should be understood that any number of clients 1206 can communicate with the computing environment 1202.

In the illustrated configuration, the computing environment 1202 includes application servers 1208, data storage 1210, and one or more network interfaces 1212. According to various implementations, the functionality of the application servers 1208 can be provided by one or more server computers that are executing as part of, or in communication with, the network 1204. The application servers 1208 can host various services, virtual machines, portals, and/or other resources. In the illustrated configuration, the application servers 1208 host one or more virtual machines 1214 for hosting applications or other functionality. According to various implementations, the virtual machines 1214 host one or more applications and/or software modules for implementing aspects of the functionality disclosed herein. It should be understood that this configuration is illustrative and should not be construed as being limiting in any way. The application servers 1208 can also host or provide access to one or more portals, link pages, Web sites, and/or other information (“web portals”) 1216.

According to various implementations, the application servers 1208 also include one or more queue management services 1218 and one or more view creation services 1220. The queue management services 1218 can include services assigning priority scores and default orders to items in a queue. The view creation services 1220 can include services that identify logic subsets of items in a queue and organize those items as a separate view. The application servers 1208 also may include one or more UI generation services 1222. The UI services 1222 can create data or images for one or more user interfaces including graphical user interfaces, audio user interfaces, etc. The UIs generated by the UI generation services 1222 may be any of that UIs shown in FIGS. 4-8.

As shown in FIG. 12, the application servers 1208 also can host other services, applications, portals, and/or other resources (“other resources”) 1224. The other resources 1224 can include, but are not limited to, mapping, machine learning, query analysis, rendering or any other functionality. It thus can be appreciated that the computing environment 1202 can provide integration of the concepts and technologies disclosed herein with various webpages, queue management, view creation, UI generation, and/or other services or resources.

As mentioned above, the computing environment 1202 can include the data storage 1210. According to various implementations, the functionality of the data storage 1210 is provided by one or more databases operating on, or in communication with, the network 1204. The functionality of the data storage 1210 also can be provided by one or more server computers configured to host data for the computing environment 1202. The data storage 1210 can include, host, or provide one or more real or virtual datastores 1226A-1026N (hereinafter referred to collectively and/or generically as “datastores 1226”). The datastores 1226 are configured to host data used or created by the application servers 1208 and/or other data. The datastore 104 introduced FIG. 1 may be one of the datastores 1226. Although not illustrated in FIG. 12, the datastores 1226 also can host or store web page documents, word documents, search queries, data structures, algorithms for execution by a recommendation engine, and/or other data utilized by any application program or other module. Aspects of the datastores 1226 may be associated with a service for storing data units such as files.

The computing environment 1202 can communicate with, or be accessed by, the network interfaces 1212. The network interfaces 1212 can include various types of network hardware and software for supporting communications between two or more computing devices including, but not limited to, the computing devices and the servers. It should be appreciated that the network interfaces 1212 also may be utilized to connect to other types of networks and/or computer systems.

It should be understood that the distributed computing environment 1200 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1200 provides the software functionality described herein as a service to the computing devices. It should also be understood that the computing devices can include real or virtual machines including, but not limited to, server computers, web servers, personal computers, mobile computing devices, smartphones, and/or other devices. As such, various configurations of the concepts and technologies disclosed herein enable any device configured to access the distributed computing environment 1200 to utilize the functionality described herein for providing the techniques disclosed herein, among other aspects. In one specific example, as summarized above, techniques described herein may be implemented, at least in part, by a web browser application, which works in conjunction with the application servers 1208 of FIG. 12.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A method comprising: defining a default priority ordering for a plurality of items in a queue; accessing the queue containing the plurality of items; receiving a definition of a first view comprising a first tier-attribute filter; generating a first logic subset of the queue based on the definition of the first view; assigning the first logic subset of the queue to an entity; ordering the first logic subset for the entity with respect to a second logic subset also assigned to the entity; and presenting a highest-priority item to the entity based on the ordering of the first logic subset and the second logic subset.

Clause 2. The method of clause 1, wherein the plurality of items in the queue are ordered according to a default priority based on tier attributes and attribute values.

Clause 3. The method of clause 2, wherein the default priority is implemented by using a priority order assigned to the attribute values and a priority order assigned to the tier attributes to generate a single numeric score for each of the plurality of items in the queue.

Clause 4. The method of any of clauses 1-3, wherein the plurality of items in the queue are randomly ordered.

Clause 5. The method of any of clauses 1-4, wherein the entity comprises an agent or a team of agents.

Clause 6. The method of any of clauses 1-5, further comprising upon acceptance of the highest-priority item by the entity, removing the highest-priority item from the queue.

Clause 7. Computer-readable storage media comprising instructions that when executed by one or processing units as a computing device to perform any of the methods of clauses 1-6.

Clause 8. A system comprising: one or more processing units; and memory storing instructions that, when executed, cause the one or more processing units to perform the methods of any of clauses 1-6.

Clause 9. A system for managing items in a queue, the system comprising: one or more processing units; and memory storing instructions that, when executed, cause the one or more processing units to: receive a queue of items having a priority order implemented by a priority score assigned each of the items in the queue; receive a definition of a first logic subset of the items in the queue comprising a first tier-attribute filter specifying a first set of tier attributes for inclusion in the first logic subset; receive a definition of a second logic subset comprising a second tier-attribute filter specifying a second set of attributes for includes in the second logic subset; receive from a user interface (UI) an indication of assignment of the first logic subset and the second logic subset to an entity; and receive from the UI an indication of a priority order of the first logic subset and the second logic subset with respect to the entity.

Clause 10. The system of clause 9, wherein the definition of the first tier-attribute filter indicates a tier attribute and an attribute value that are present for all items in the first logic subset of the items.

Clause 11. The system of clause 9 or 10, wherein the UI comprises a graphical user interface (GUI) including an ordered list in which an order of the list can be visibly changed to provide the indication of the priority order of the first logic subset and the second logic subset.

Clause 12. The system of any of clauses 9-11, wherein the priority score for each of the items in the queue is a numeric score based on a priority order of multiple tier attributes and on a priority order for the attribute values within each of the respective ones of the multiple tier attributes.

Clause 13. The system of clause 12, wherein the UI comprises a graphical user interface (GUI) including an ordered list in which an order of the list can be visibly changed to change an ordering of the attribute values or the tier attributes and in response to the change, changing the priority score assigned to the items in the queue.

Clause 14. The system of any of clauses 9-13, wherein an order of the items in the queue is based on the priority score for each of the items and further sorted according to values of a continuously variable tier attribute.

Clause 15. A system for managing items in a queue, the system comprising: means for processing; a memory coupled to the means for processing; means for receiving a queue of items having a priority order implemented by a priority score assigned each of the items in the queue; means for receiving a definition of a first logic subset of the items in the queue comprising a first tier-attribute filter specifying a first set of tier attributes for inclusion in the first logic subset; means for receiving a definition of a second logic subset comprising a second tier-attribute filter specifying a second set of attributes for includes in the second logic subset; means for receiving from a user interface (UI) an indication of assignment of the first logic subset and the second logic subset to an entity; and means for receiving from the UI an indication of a priority order of the first logic subset and the second logic subset with respect to the entity.

Clause 16. A method of ordering a plurality of items in a queue, the method comprising: receiving a priority order of tier attributes; receiving a priority order of attribute values; assigning a priority score to each item in the queue based on attributes and attribute values associated with the item and on the priority order of tier attributes and the priority order of attribute values; and ordering the items in the queue according to priority scores.

Clause 17. The method of clause 16, wherein each of the attribute values is mapped to a numeric value and the priority score is created by concatenating numeric values for the attribute values according to the priority order of the tier attributes.

Clause 18. The method of clause 17, wherein a one of the attribute values that is a continuously variable value is binned into discrete bins each associated with a single numeric value.

Clause 19. The method of any of clauses 16-18, further comprising for items having a same priority score, sorting the items having the same priority score according to an attribute that has a continuously variable value.

Clause 20. The method of any of clauses 16-19, further comprising identifying a logic subset of the items in the queue based on a tier-attribute filter, wherein the logic subset of the items is ordered according to the priority score.

Clause 21. The method of clause 20, further comprising assigning the logic subset of the items to an entity.

Clause 22. The method clause 21, wherein the assigning is based on a characteristic of the entity and an attribute value of the items in the logic subset of the items.

Clause 23. The method of any of clauses 16-22, further comprising receiving a change to the priority order of tier attributes or to the priority order of attribute values and updating the priority score for the items in the queue.

Clause 24. Computer-readable storage media comprising instructions that when executed by one or processing units as a computing device to perform any of the methods of clauses 16-23.

Clause 25. A system comprising: one or more processing units; and memory storing instructions that, when executed, cause the one or more processing units to perform the methods of any of clauses 16-23.

### CONCLUSION

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context.

It should be appreciated that any reference to “first,” “second,” etc. users or other elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different users, two different virtual machines, etc.).

Certain embodiments are described herein, including the best mode known to the inventors for carrying out the invention. Of course, variations on these described embodiments will become apparent to those of ordinary skill in the art upon reading the foregoing description. Skilled artisans will know how to employ such variations as appropriate, and the embodiments disclosed herein may be practiced otherwise than specifically described. Accordingly, all modifications and equivalents of the subject matter recited in the claims appended hereto are included within the scope of this disclosure. Moreover, any combination of the above-described elements in all possible variations thereof is encompassed by the invention unless otherwise indicated herein or otherwise clearly contradicted by context.

1. A method comprising:
defining a default priority ordering for a plurality of items in a queue;
accessing the queue containing the plurality of items;
receiving a definition of a first view comprising a first tier-attribute filter;
generating a first logic subset of the queue based on the definition of the first view;
assigning the first logic subset of the queue to an entity;
ordering the first logic subset for the entity with respect to a second logic subset also assigned to the entity; and
presenting a highest-priority item to the entity based on the ordering of the first logic subset and the second logic subset.

2. The method of claim 1, wherein the plurality of items in the queue are ordered according to a default priority based on tier attributes and attribute values.

3. The method of claim 2, wherein the default priority is implemented by using a priority order assigned to the attribute values and a priority order assigned to the tier attributes to generate a single numeric score for each of the plurality of items in the queue.

4. The method of claim 1, wherein the plurality of items in the queue are randomly ordered.

5. The method of claim 1, wherein the entity comprises an agent or a team of agents.

6. The method of claim 1, further comprising upon acceptance of the highest-priority item by the entity, removing the highest-priority item from the queue.

7. A system for managing items in a queue, the system comprising:
one or more processing units; and
memory storing instructions that, when executed, cause the one or more processing units to:
receive a queue of items having a priority order implemented by a priority score assigned each of the items in the queue;
receive a definition of a first logic subset of the items in the queue comprising a first tier-attribute filter specifying a first set of tier attributes for inclusion in the first logic subset;
receive a definition of a second logic subset comprising a second tier-attribute filter specifying a second set of attributes for includes in the second logic subset;
receive from a user interface (UI) an indication of assignment of the first logic subset and the second logic subset to an entity; and
receive from the UI an indication of a priority order of the first logic subset and the second logic subset with respect to the entity.

8. The system of claim 7, wherein the definition of the first tier-attribute filter indicates a tier attribute and an attribute value that are present for all items in the first logic subset of the items.

9. The system of claim 7, wherein the UI comprises a graphical user interface (GUI) including an ordered list in which an order of the list can be visibly changed to provide the indication of the priority order of the first logic subset and the second logic subset.

10. The system of claim 7, wherein the priority score for each of the items in the queue is a numeric score based on a priority order of multiple tier attributes and on a priority order for the attribute values within each of the respective ones of the multiple tier attributes.

11. The system of claim 10, wherein the UI comprises a graphical user interface (GUI) including an ordered list in which an order of the list can be visibly changed to change an ordering of the attribute values or the tier attributes and in response to the change, changing the priority score assigned to the items in the queue.

12. The system of claim 11, wherein an order of the items in the queue is based on the priority score for each of the items and further sorted according to values of a continuously variable tier attribute.

13. A method of ordering a plurality of items in a queue, the method comprising:
receiving a priority order of tier attributes;
receiving a priority order of attribute values;
assigning a priority score to each item in the queue based on attributes and attribute values associated with the item and on the priority order of tier attributes and the priority order of attribute values; and
ordering the items in the queue according to priority scores.

14. The method of claim 13, wherein each of the attribute values is mapped to a numeric value and the priority score is created by concatenating numeric values for the attribute values according to the priority order of the tier attributes.

15. The method of claim 14, wherein a one of the attribute values that is a continuously variable value is binned into discrete bins each associated with a single numeric value.

16. The method of claim 13, further comprising for items having a same priority score, sorting the items having the same priority score according to an attribute that has a continuously variable value.

17. The method of claim 13, further comprising identifying a logic subset of the items in the queue based on a tier-attribute filter, wherein the logic subset of the items is ordered according to the priority score.

18. The method of claim 17, further comprising assigning the logic subset of the items to an entity.

19. The method of claim 18, wherein the assigning is based on a characteristic of the entity and an attribute value of the items in the logic subset of the items.

20. The method of claim 13, further comprising receiving a change to the priority order of tier attributes or to the priority order of attribute values and updating the priority score for the items in the queue.
